(19) United States
(12) Patent Application Publication
(10) Pub. No.: US 2010/0031631 A1
(43) Pub. Date: Feb. 11, 2010

(54) GAS TURBINE COMPRISING A GUIDE RING AND A MIXER

(75) Inventor: Guenter Ramm, Eichenau (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 12/525,158

(22) PCT Filed: Jan. 26, 2008
(86) PCT No.: PCT/DE08/00144

§ 371 Date: Jul. 30, 2009

(30) Foreign Application Priority Data
Jan. 31, 2007 (DE) 10 2007 004 741.1

(51) Int. Cl. F02K 1/38

(52) U.S. Cl. 60/262

(57) ABSTRACT

A gas turbine is disclosed. The gas turbine includes a rotor which is driven by a turbine, a stator, struts that are fixed to the stator downstream from the turbine and that configure a guide ring for deflecting the rotational flow of hot gas, and a mixer arranged on the downstream end of the hot gas channel. The guide ring and the mixer are structurally and fluidically combined, the struts of the guide ring being connected to the wall structure of the mixer in the region of their radially outer ends.

This application claims the priority of International Application No. PCT/DE2008/000144, filed Jan. 26, 2008, and German Patent Document No. 10 2007 004 741.1, filed Jan. 31, 2007, the disclosures of which are expressly incorporated by reference herein.

### BACKGROUND AND SUMMARY OF THE INVENTION

The invention relates to a gas turbine comprising at least a rotor which is driven by a turbine, and a stator, struts that are fixed to the stator downstream from the turbine or the rearmost turbine and that configure a guide ring, and a mixer arranged on the downstream end of the hot gas channel.

In the case of gas turbines that are used as aircraft engines, the, as a rule rotational, flow of hot gas exiting from the rearmost turbine stage is deflected in the axial direction typically with the aid of a guide ring fixed to the stator, also called a guide vane. This results in an increase in the axial thrust, and furthermore the torsional load of the engine mount and therefore of the airframe is reduced. In the case of fan engines, these types of guide rings having profiled struts are also common in “cold” bypass flow downstream from the fans that may be generating the main portion of the thrust.

Known devices for reducing noise in aircraft engines and other gas turbines are so-called mixers. They add ambient air with lower energy, i.e., with considerably lower temperature and lower speed, to the high-energy flow of hot gas exiting from the turbine area. In the case of engines with a bypass flow/bypass, bypass air is added to the flow of hot gas. As a rule, the mixed flow that is generated then emits less noise than the unmixed flow of hot gas. In the case of military aircraft, mixers are also used to reduce the infrared signature of the jetwash in order to make it more difficult to track the aircraft. As a result, mixers are static as well as passive devices without their own power supply. As the degree of mixing increases, the flow losses also increase as a rule. A good mixer therefore represents a compromise between these two effects.

The design most used is arguably the so-called bloom mixer, named for the bloom-like geometry when viewed from the behind. In the case of this design, radial elevations and depressions follow one after the other in an undulated manner and lead in a self-contained manner at least approximately between circular paths around a center point. In the elevations, hot gas is channeled radially outward, and, in the depressions, ambient air is guided radially inward. See, for example, U.S. Pat. No. 4,819,425 in this regard.

Another design is devised according to a type of cone-shaped shell with openings distributed over the circumference and is also designated as a hole mixer. See Unexamined German Patent Application DE 101 45 489 A1 in this regard.

There are also hybrids between a bloom mixer and a hole mixer as well as a multitude of other designs with very differently devised and distributed flow channels. The fundamental functional principle is normally retained in the process.

It becomes clear from the pertinent publications on the mixer topic that the mixer is viewed as a structurally and functionally self-contained device, which is installed as an additional element on a gas turbine or an aircraft engine.

On the other hand, the objective of the invention is improving a gas turbine having a guide ring/guide vane downstream from the rearmost turbine stage and having a mixer on the downstream end of the hot gas channel in such a way that, with greater engine efficiency, savings can be achieved in the construction length, weight and number of parts.

The invention consists of the guide ring and the mixer being structurally and fluidically and functionally combined, wherein the flow-deflecting struts of the guide ring are connected to the wall structure of the mixer in the region of their radially outer ends. Therefore, a combination element is formed by the guide ring and mixer, which is characterized by a shorter construction length, lower weight, fewer parts and higher structural mechanical loading capacity. An improvement in efficiency is also to be expected by downsizing the channel surfaces that are impacted by the flow. The attainment is not linked to any specific design of the mixer, but is aimed preferably at bloom mixers.

### BRIEF DESCRIPTION OF THE DRAWINGS

The invention will be explained in greater detail in the following on the basis of the drawings. The drawings show the following in a simplified, more schematic representation:

FIG. 1 is a partial longitudinal section through a gas turbine in the outlet region of its hot gas channel,

FIG. 2 is a partial section of the gas turbine according to FIG. 1 in the axial direction from the rear,

FIG. 3 is a partial section through the gas turbine according to section line A-A in FIG. 1, and

FIG. 4 is a partial section through the gas turbine according to section line B-B in FIG. 1.

### DETAILED DESCRIPTION OF THE DRAWINGS

A combination of the elements affecting flow, i.e., the guide ring 6 and mixer 8, is primarily of interest for gas turbines embodied as aircraft engines, in which an optimized, non-rotational axial thrust and minimized noise emissions are of significance. Among aircraft engines, it is especially civilian fan engines, i.e., bypass engines, which must satisfy these criteria. However, this does not rule out that the invention may also be advantageous for stationary gas turbines or non-aircraft gas turbines.

The figures exclusively depict one variant with a mixer 8 embodied as a bloom mixer. The invention can also be realized with other mixer designs, e.g., with hole mixers or solutions combining bloom mixers and hole mixers.

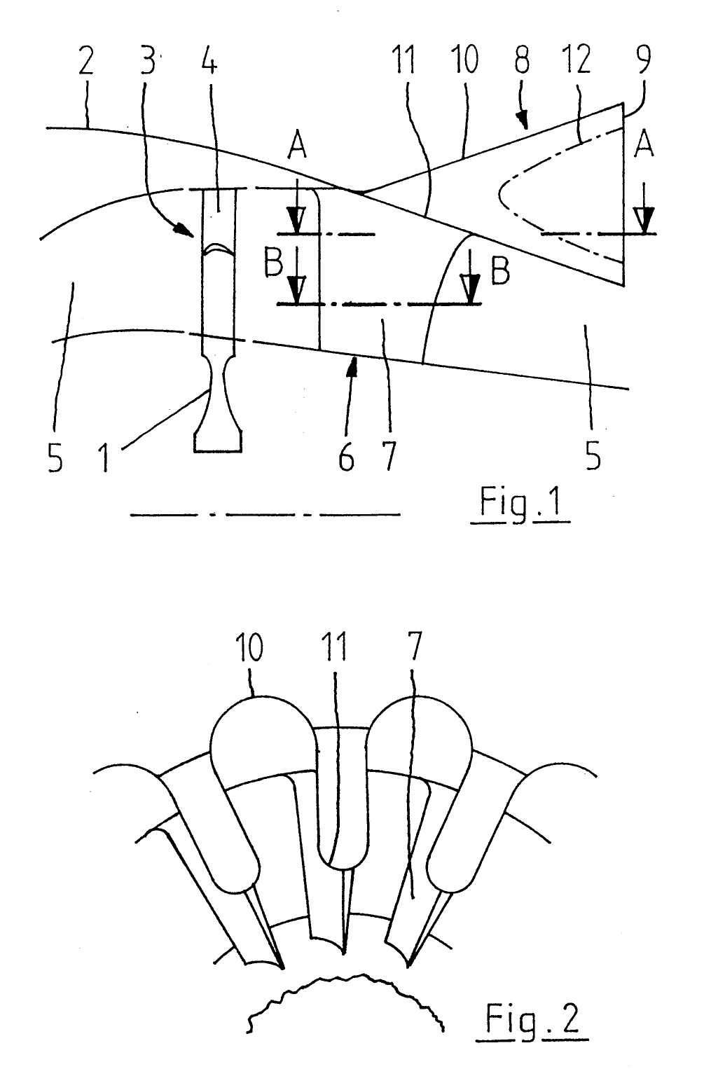

The gas turbine or the aircraft engine according to FIG. 1 is comprised of at least a rotor 1 as well as a stator 2 accommodating the rotor 1. Only one guide blade ring 4 of the turbine 3 driving the rotor 1 is depicted. If several turbines and rotors are present, the turbine 3 should be the low-pressure turbine positioned furthest downstream as well as the guide blade ring 4 arranged furthest downstream. The flow going through the hot gas channel 5 is from the left to the right and ends on the downstream end of the mixer 8. The hot gas exiting from the rearmost guide blade ring 4 with rotation, i.e., with a relevant circumferential component, is deflected in the axial direction by the profiled and curved, essentially radially arranged, struts 7 of the guide ring and is therefore as non-rotational as possible. The guide ring 6 and the mixer 8 are combined into a structural and functional unit, wherein the radial outer ends of the struts 7 are connected to the wall structure 9 of the mixer 8. The mixer 8 has consecutive radial elevations 10 and depressions 11 in the circumferential direction, which run in a meandering manner between virtually, at least approximately, rotationally symmetrical boundary surfaces, e.g., conical or cylindrical surfaces, and create a bloom-like geometry. In doing so, the depressions 11 dip into the flow of hot gas, and the elevations into the surrounding air flow/shell flow and produce the desired mixing of the flow media downstream. As an option, recesses 12 (dashed and dotted line) and/or holes as well as additional channel elements may be present in the wall structure 9 of the mixer 8, which produce additional mixing processes. In the region of its radially outer end, each strut 7 is connected at least in large part with a radial depression 11 of the wall structure 9. The number of depressions 11 may be equal to, or a whole-number multiple of, the number of struts 7.

According to FIG. 2, the number of depressions 11 and the number of elevations 10 coincides with the number of struts 7, i.e., each depression 11 is assigned to a strut 7. The bloom geometry of the mixer 8 is also easy to see in this case.

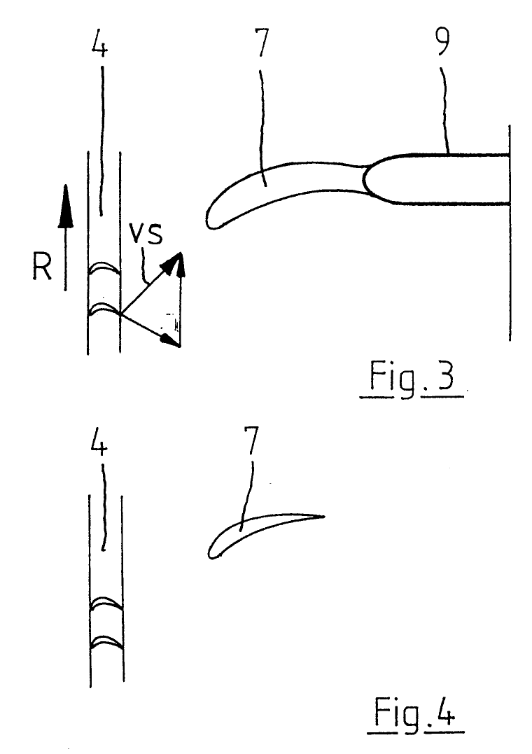

FIG. 3 is yielded by a horizontal partial section in accordance with line A-A in FIG. 1. The guide blade ring 4 with its rotational direction R and a velocity triangle on its outlet side can be seen on the left. The resulting speed vector vs in a reference system fixed to the stator is directed from the lower left to the upper right. The flow-deflecting strut 7 is curved in such a way that the direction of the speed vector vs runs approximately tangentially to the profile center line of the strut 7 in the region of its inlet edge so that a favorable inflow that is as low-loss as possible occurs. Bear in mind in the case of the depiction in FIG. 3 that there are corresponding transitional radii in the transition area from the strut 7 to the wall structure 9 of the mixer 8 so that the outlet edge of the strut 7 at this radial height is not sharp-edged.

FIG. 4 shows a horizontal partial section in accordance with section line B-B in FIG. 1, i.e., at a low radial height. In this case, it is easy to see that the strut 7 has a profile that is favorable for flow with a sharp outlet edge as well as an axial, in this case horizontal, flow outlet direction. This applies approximately for the entire radial height of each strut 7.

On their radial ends, the struts can be connected for example via a ring-like element or be fastened or guided into the inner stator structure. This is unimportant in terms of the principle of the invention.

1-6. (canceled)

7. A gas turbine, comprising a rotor which is driven by a turbine, a stator, struts that are fixed to the stator downstream from the turbine and that configure a guide ring for deflecting a rotational flow of hot gas, and a mixer arranged on a downstream end of a hot gas channel, wherein the guide ring and the mixer are structurally and fluidically combined such that the struts of the guide ring are connected to a wall structure of the mixer in a region of a radially outer end of the struts.

8. The gas turbine according to claim 7, wherein the mixer has a form of a bloom mixer, and wherein in the region of the radially outer end of the struts, each strut of the guide ring is connected with a radial depression of the wall structure of the mixer.

9. The gas turbine according to claim 7, wherein the struts of the guide ring are connected in an upstream portion of the mixer.

10. The gas turbine according to claim 7, wherein the struts of the guide ring are integrally connected to the wall structure of the mixer.

11. The gas turbine according to claim 7, wherein the mixer has a form of a bloom mixer, and wherein a number of radial depressions of the mixer is equal to, or a whole-number multiple of, a number of struts of the guide ring.

12. The gas turbine according to claim 7, wherein the mixer has a form of a bloom mixer, and wherein in a transition area from a radial depression to a radial elevation, a wedge-like recess is present in the wall structure extending up to a downstream end of the mixer.

13. The gas turbine according to claim 7, wherein the gas turbine is an aircraft engine.

14. The gas turbine according to claim 7, wherein the mixer is a bloom mixer having alternating radial elevations and depressions over a circumference of the mixer.
